(19) United States
(12) Patent Application Publication
(10) Pub. No.: US 2005/0001345 A1
(43) Pub. Date: Jan. 6, 2005

(54) Method and apparatus for applying a pattern to a molded surface during manufacture

(76) Inventors: Edward A. Frank, Oak Ridge, NJ (US); Andrew P. Frank, Oak Ridge, NJ (US); Sandra A. Shaffer, Butler, NJ (US)

Correspondence Address: BLACKWELL SANDERS PEPER MARTIN LLP, 720 OLIVE STREET, SUITE 2400, ST. LOUIS, MO, 63101, US

(21) Appl. No.: 10/686,281

(22) Filed: Oct. 15, 2003

Related U.S. Application Data
(60) Provisional application No. 60/320,089, filed on Apr. 4, 2003.

(51) Int. Cl. B29C 47/00; A01N 1/00; G09B 11/00; A47G 35/00; B44C 1/00

(52) U.S. Cl. 264/75; 428/542.2; 428/16; 434/82; 156/59

(57) ABSTRACT

A process that achieves a striping or pin-striping or other specified pattern decoration on molded surfaces during manufacturing. This process begins by engraving the stripe or other pattern into the surface of the initial sculpted figurine in the specified area. The stripe engraving or other pattern can be as thick or thin as desired but typically between 0.25 mm to 0.5 mm thick and between 0.1 mm to 1 mm deep below the surface. The stripe pattern is engraved on the surface of the original model master figurine when the figurine is initially sculpted.

### CROSS REFERENCE

This application claims the benefit of U.S. Provisional Application S/No. 60/320,089

### BACKGROUND OF INVENTION

1. Field of Invention

This invention relates generally to manufacturing molded objects and, more particularly, relates to applying a specified pattern decoration on a surface of a molded object.

2. Background Art

Small molded objects such as figurines or collectible sculpted action figures of ten times have to be manufactured with specified detailed pattern decorations in order to make the figurine more life-like. For example, it is common that the decoration specifications required for a molded object for a sports property will include a specific detailed pattern decoration and the pattern must be applied to the product, such as a pin-striping detail. It is common for products that require this type of detail to be manufactured using a mask and spray method and/or a hand paint method. The standard methods typically render inconsistent and poor results. The detail pattern decorations when applied using these methods can be sloppy, uneven and inconsistent from product to product.

Considering the scope and magnitude of the problem with the sloppy and inconsistent decoration seen in many products, it is clear that an improvement in the process is needed. A process is needed that can be performed repetitively and consistently. The common methods used on many products rely on a process were all the decoration detail is added at the factory level and therefore created new on every individual piece. Creating the decoration detail completely at the factory invites inconsistency. A method is needed that will achieve the decoration pattern by simplifying the process at the manufacturing level. The method of choice should not only allow for less defects and greater consistency in the decoration but allow for finer more accurate detail.

### BRIEF SUMMARY OF INVENTION

The present invention is a process that achieves a striping or pin-striping or other specified pattern decoration on molded surfaces during manufacturing. This process begins by engraving the stripe or other pattern into the surface of the initial sculpted figurine in the specified area. The stripe engraving or other pattern can be as thick or thin as desired but typically between 0.25 mm to 0.5 mm thick and between 0.1 mm to 1 mm deep below the surface. The stripe pattern is engraved on the surface of the original model master figurine when the figurine is initially sculpted.

This engraving process is typically accomplished with a sculpting tool marking and creating a recess in the clay, wax or other sculpting medium. The engraving process can also be applied to the figurine with a sharp engraving tool after the figurine is made into the hard material necessary to create a tooling pattern. The tooling pattern is the master copy that is prepared to facilitate manufacturing. The engraving process could also be applied to the figurine formed in casting ceramic.

The striping detail is then transferred into the surface of the mold used for manufacturing. This mold is typically an injection mold made of steel with barrillium copper inserts. The master sculpted figurine or a mold master figurine developed therefrom is used to create the mold. The mold yields a plastic part(s) which includes the recessed striping detail or whatever detail pattern that was originally engraved in the sculpted master.

For one embodiment of the process, the paint is applied to the engraved stripes using the mask and spray method. This is achieved by magnetically charging the molded figurine everywhere but the engraved design portions. The magnetic charging is accomplished by first applying a coating in order to magnetically charge the areas to be masked, i.e. all but the recessed engraved design portions. Next, the figurine or a portion thereof is submerged in a liquid bath containing copper particles where the bath container has a means for agitating the liquid bath.

The copper particles as they are agitated and disperse throughout the liquid will adhere to the magnetically charged portions of the figurine creating a copper mask on those charged surfaces. This mask can be removed and reused with subsequent figurines. With the mask applied, paint can be sprayed on the figurine and the paint will only be applied to the exposed portions of the figurine, which are the engraved design portions. The mask is then removed. This method foregoes the need to wipe the paint away and results in a more faithful paint application. However, there can be an optional wiping step to wipe away any paint that may have applied on the wrong surface or that may have bled under the mask.

In another embodiment a paint wash and wipe method is used. A paint wash in the specified color is applied to the plastic parts with a brush, cloth, sponge, or other applicator. A paint wash includes a thinned or diluted paint that can be easily wiped substantially clean from a surface to which it was applied while having sufficient consistency to remain in and color the recessed engravings or lines of the detailed design. A cloth is then applied to the plastic parts to remove the paint wash from the surface with a wiping action while leaving the paint wash only in the recesses of the molded piece originally made in the engraving and transferred to the mold. This completed process decorates the figurine in the striping pattern in the specified color.

The surface of the part could optionally have a pre-preparation performed such that the paint is easily wiped away from the surface while leaving the paint in the recessed areas or the cloth could be optionally specially treated. For example, a primary base paint having the desired color could be applied to the surface of the molded part prior to applying the paint wash, and other pre-preparations can be applied. The optimal timing between application of the paint wash and wiping away of the paint wash may vary based on the level of thinning of the paint and the type of base paint and/or surface treatment.

It is clear that the sloppy inconsistent decoration seen with similar products using the standard processes is improved by utilizing the present invention, which adds much of the detail to the prototype or the initial sculpted piece. The prototype needs only to have the detail engraved once and therefore by definition is correct. The common method used for typical products rely on a process were all the decoration detail is added at the factory level after each part has been molded and therefore created new on every individual piece. Creating this decoration detail completely at the factory invites inconsistency. The present invention is a method, which achieves the pinstriped pattern or other detailed pattern by simplifying the process at the manufacturing level. The engrave-wash and wipe method not only provides for less defects and greater consistency in the decoration but allows for finer more accurate detail.

### BRIEF DESCRIPTION OF THE DRAWINGS

For a better understanding of the present invention, reference may be made to the accompanying drawing.

FIG. 1 is a photograph of a clay sculpted model master showing engraved pin-strips.

FIG. 2 is a photograph of the unpainted plastic parts having a pin-strip design, which was produced with the engrave and mold process prior the wash.

FIG. 3 is a photograph of a finished painted sample sport figurine having a pin-stripe design, which was produced with the engrave, mold and wash process.

FIG. 4 is a cross section of a mold.

FIGS. 5-7 are examples of the types of tools that can be utilized for creating the detailed design pattern in the sculpted master.

### DETAILED DESCRIPTION OF THE INVENTION

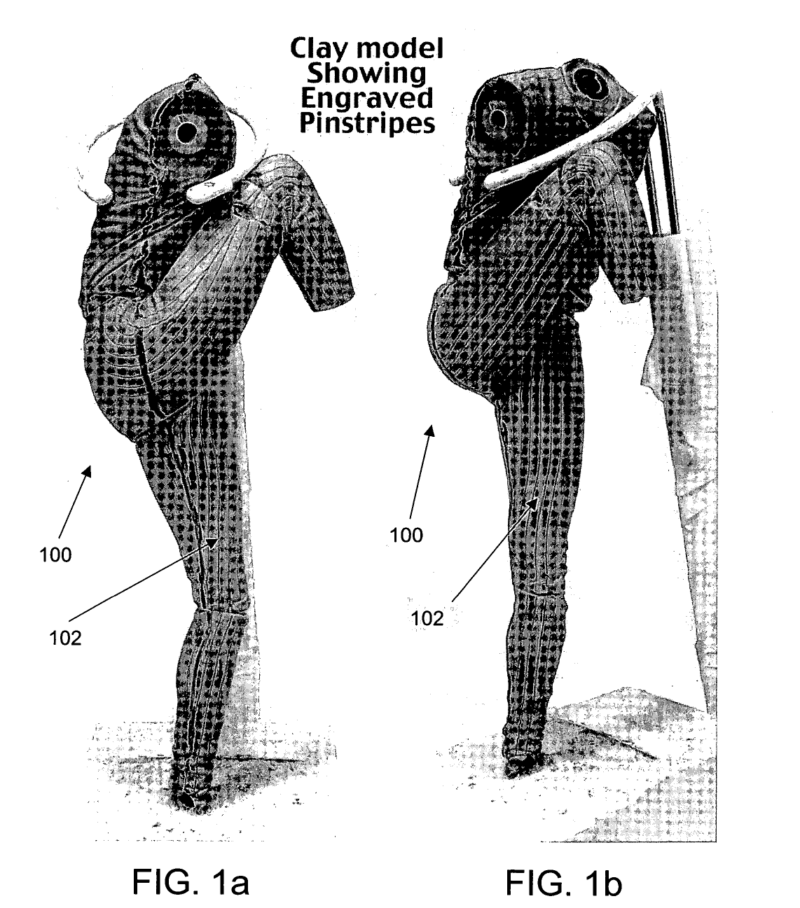

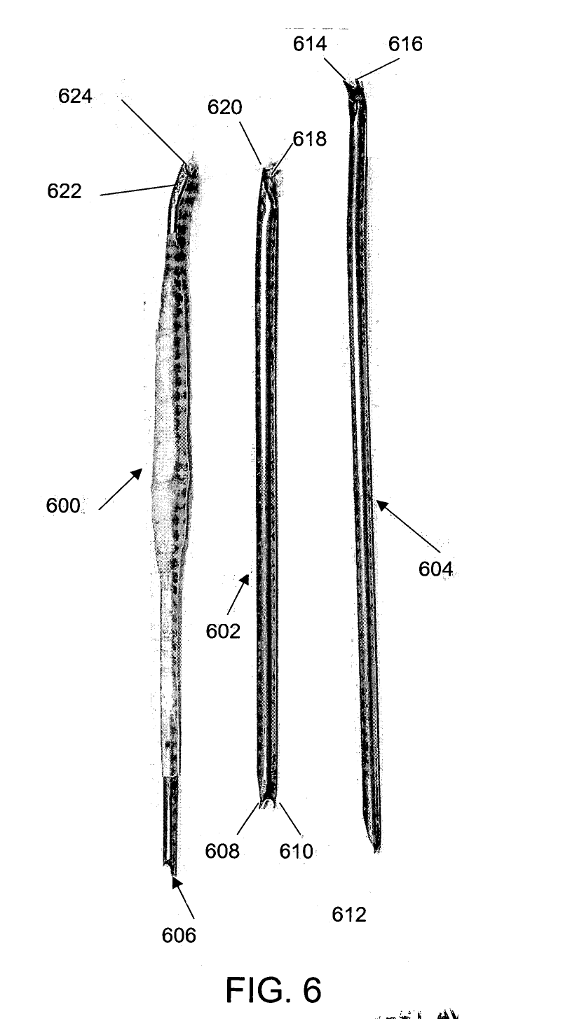

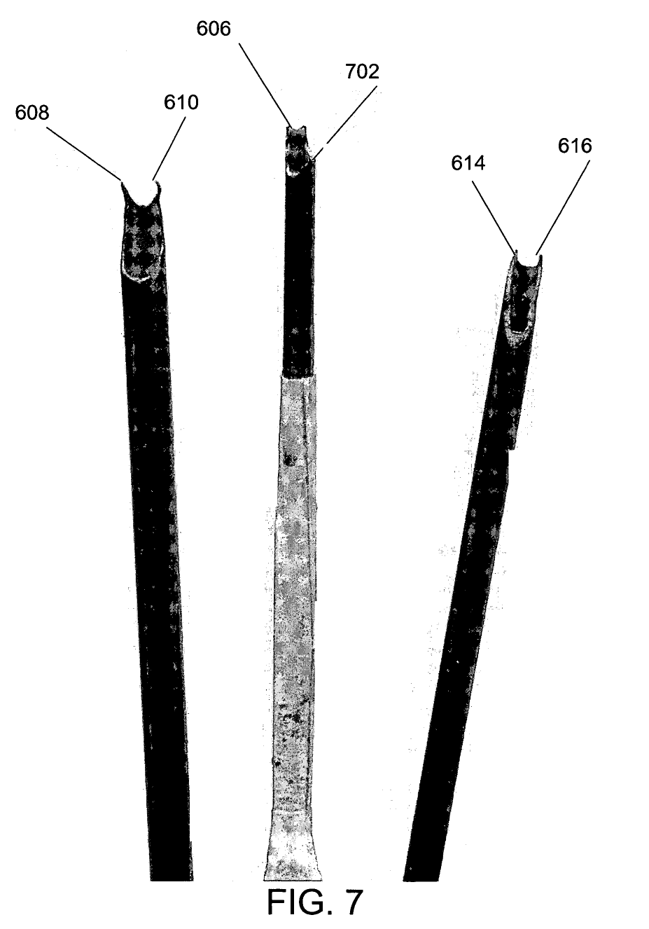

According to the embodiment(s) of the present invention, various views are illustrated in FIGS. 1-7 and like reference numerals are being used consistently throughout to refer to like and corresponding parts of the invention for all the various views and figures of the drawing. Also, please note that the first digit(s) of the reference number for a given item or part of the invention should correspond to the Fig. number in which the item or part is first identified.

One mode of the present invention comprises the steps of engraving a recessed pattern of fine lines in a sculpted master part, creating a mold from the sculpted master part which includes protrusions corresponding to the engraved recessed pattern of fine lines in the sculpted master part, molding the final product having the recessed pattern using a mold created from the sculpted master, and applying paint using the mask and spray method. This mode of the present invention could include an additional step creating an initial mold of silicon or ceramic from the sculpted master, then using the initial mold to create a mold master part, which is utilized to create the more durable manufacturing mold of beryllium with copper inserts. Also, rather than using the mask and spray method, the wipe and wash method can be utilized.

The details of the invention and the various embodiments can be better understood by referring to the figures of the drawing. Referring to FIG. 1a and 1b, a view of an example of a sculpted original model master figurine showing engraved pinstripes. FIGS. 1a and 1b show two different perspective views of a partially assembled sculpted original model master. The partially assembled model master 100 can be utilized as a sculpted model master for a sports figurine product. The partially assembled model master 100 includes a portion of the sculpted legs and the torso. This partially assembled model master includes engraved pinstripes 102 representative of a pinstripe design of a baseball player's pant. This partially assembled model master will be completed to include all parts of the figurine.

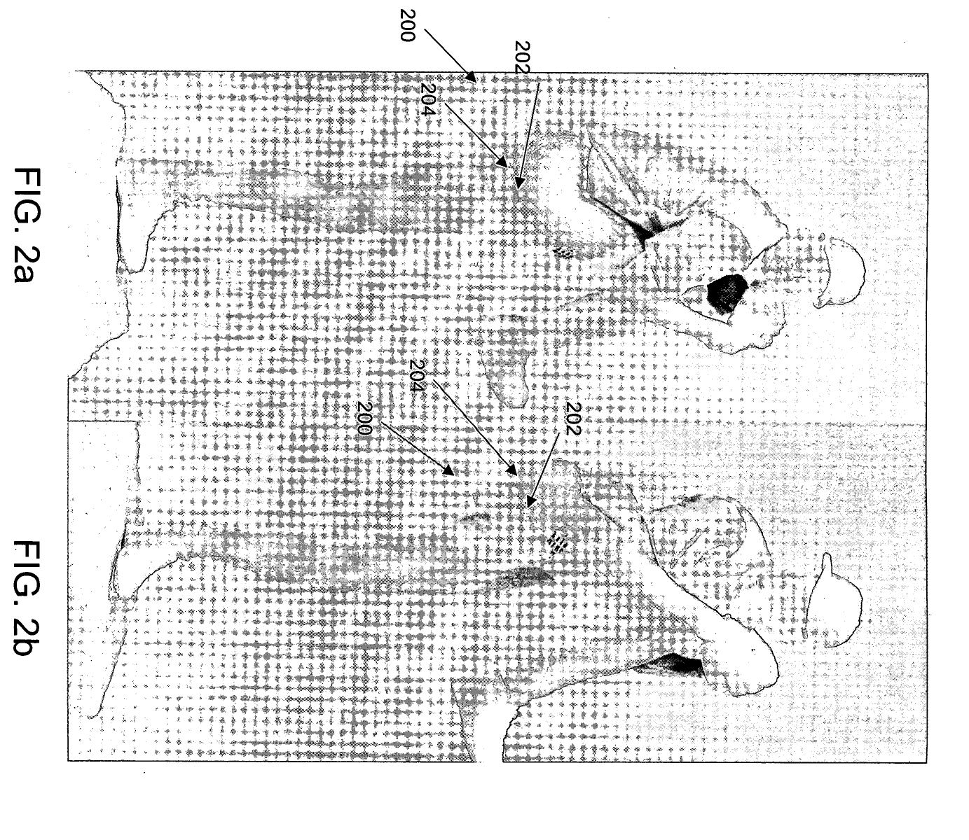

The figurine when completed will be utilized as a sculpted original model master for creating the mold for the manufacturing process or for creating a temporary mold that is used to mold a mold master of a harder material. The mold master can then be utilized to create a manufacturing mold. The interior surface of the mold will be created with protruding pinstripe lines corresponding to the engraved pinstripe lines 102. Once the manufacturing mold is completed to correspond with the sculpted original model master, subsequent plastic figurines can be created utilizing the mold as shown in FIGS. 2a and 2b.

Referring to FIGS. 2a and 2b a view of an example of an unpainted plastic figurine having a pinstripe design, which was produced with the engrave and mold process is shown prior to the paint application. The plastic model figurine 200 formed from the mold has the recessed pinstripe 202 corresponding to the engraved pinstripe design of the original sculpted model master. Between each of the lines of the pinstripe design is a smooth surface 204 which does not have a detail design.

The paint can be applied to the final manufactured figurine using the mask and spray method. In this method, a copper mask is applied to the figurine having the engraved design. This mask covers the figurine in all areas except where the paint is desired. In the present method, that area is the engraved design. The mask is formed by first applying a charge created by substance to the surface of the figurine in all areas except the engraved design portion, which will create a charge on those surfaces. This will magnetically charge the surface in the areas of application.

Next, the magnetically charged figurine is submerged in a liquid bath containing copper particles. The bath can be agitated to ensure the copper particles have adequate contact with the entire surface area of the figurine. The copper particles will magnetically adhere to the charged portions, but not the non-charged engraved design portions. The copper particles will form a solid copper mask that is removable and reusable with other identically shaped figurines.

When the mask is applied to the figurine, paint is sprayed on the exposed portions of the figurine. The mask is then removed. This process results in paint being applied to the engraved design portions only. This mask and spray method is one embodiment method of paint application because there is no need for a wash and subsequent wipe and the paint is more accurately applied. The mask and spray method in conjunction with the design engraving produces results that are uncommon in the industry.

In another embodiment of the method, a paint wash is applied to the surface of the area having the detailed design engraved therein, which in the present example is a pinstripe design. However, other designs could be formed. The paint wash is applied to the surface and then wiped away from the surface 204 between the recessed design lines leaving paint wash in the recessed line of the design 202. The paint wash remaining in the recessed areas create the desired detailed design. This process can be performed repetitively and consistently such that each figurine produced from this process will be substantially the same with consistent quality and detail.

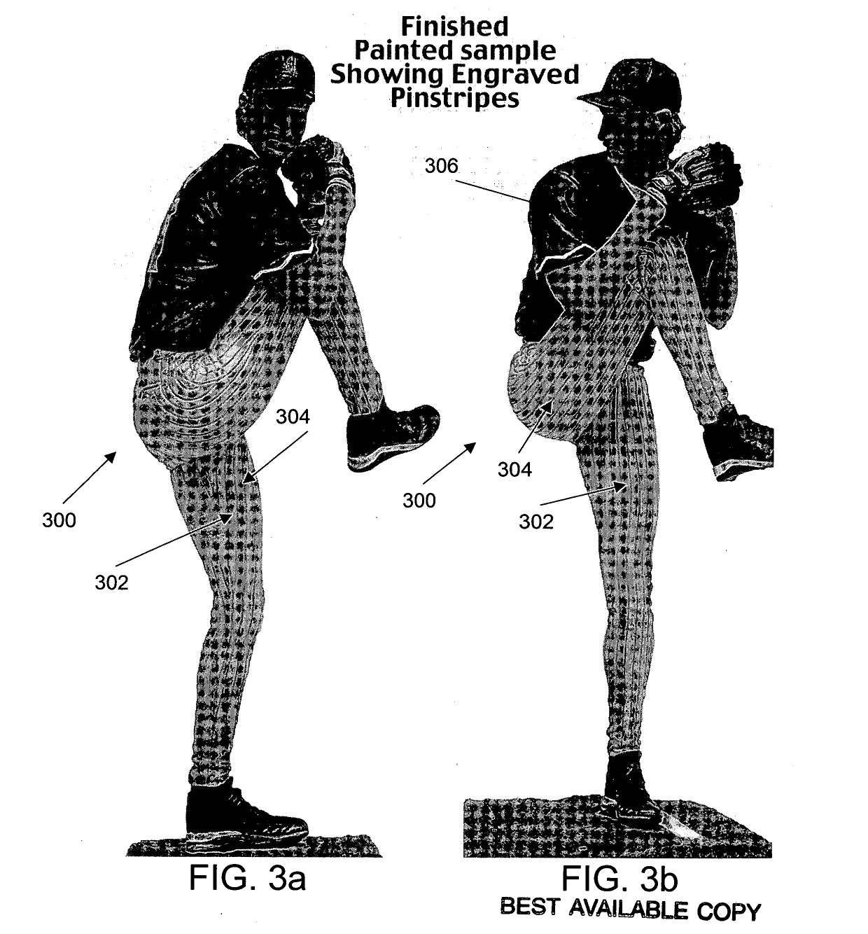

Referring to FIG. 3 a view of an example of a finished painted sport figurine having the pinstripe design, which was produced with the engraved, mold and wash process is shown. The recessed lines of the design retain the paint wash 302 forming the pinstripe design of the finished painted product 300. All paint wash has been removed from the smoothed surface 304 of the final painted product 300. The final product has multiple painted surfaces such as surface 306.

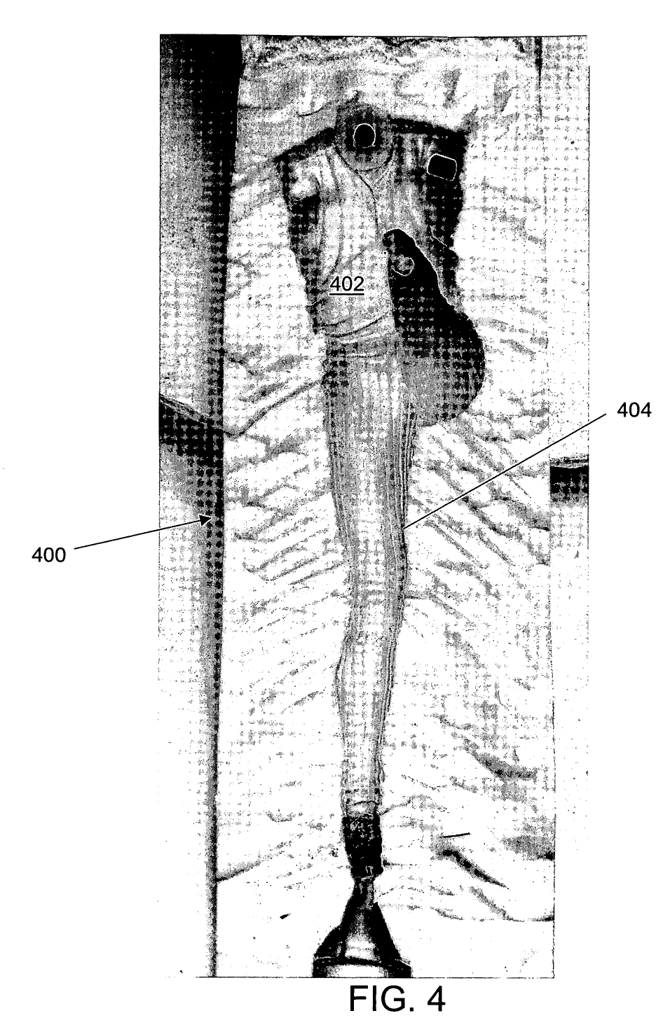

Referring to FIG. 4, a cross-section of an example of a mold is shown. The mold 400 shown here is made of a silicone or ceramic material, however, the standard mold could be made of steel with beryllium copper inserts as noted above. The mold shown is typically utilized to mold master figurine or tool rather than as a final manufacturing mold. However, the cavity 402 of the mold 400 is representative of the appearance of the interior cavity of a typical mold. The interior surface of the cavity 402 has the design detail specifically the pinstriping design pattern 404. The pinstriping pattern is created from the original sculpted master such that each subsequent part produced from the mold will closely correspond to the design pattern of the sculpted master. The pinstriping design pattern 404 protrudes from the interior surface of the mold cavity 402. These protrusion lines will create the engraved pattern on the final molded product as reflected in FIGS. 2A and 2B.

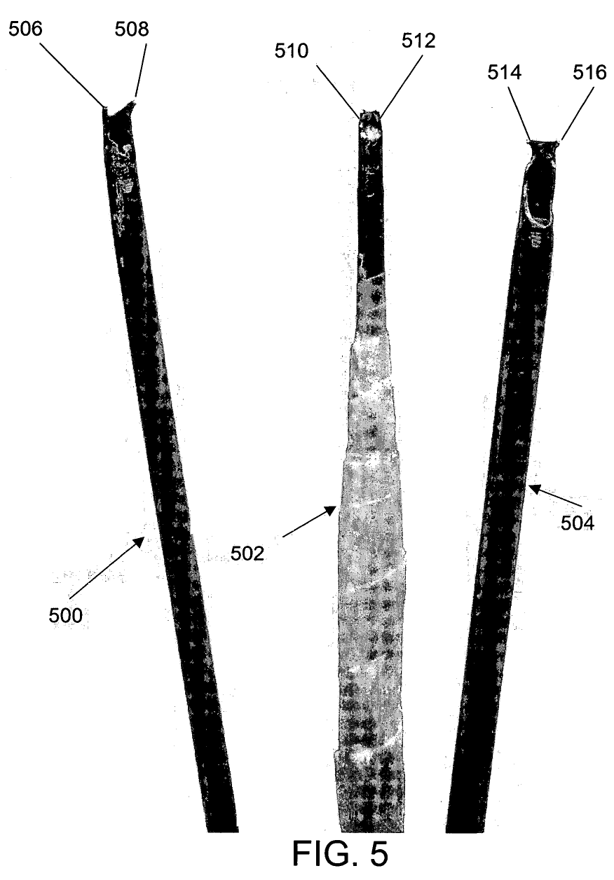

FIGS. 5-7 show examples of the types of tools that can be utilized for creating the detailed design pattern in the original sculpted master. Six representative sculpting design tools are shown and they are design tools 500, 502, 504, 600, 602 and 604. The various tools include various types of engraving tips that can be utilized to create the recessed engraving lines for the detailed design patterns to be created on the surface of the sculpted master. Many of the engraving tips of the engraving tools have blunt ends such as tips 506, 508, 510, 512, 514 and 516.

The blunt ended tips shown in FIG. 5 are shown in a double tipped or two prong configuration. The blunt ended tips when utilized to engrave a design line will make an engraving recession in the material whose sides are substantially parallel. However, the engraving tips 608, 610, 612, 614 and 616 are substantially pointed such that when they are utilized to engrave their recessed design line the sides of the engraved recession are canted inward forming a substantially v-shaped cross section. These engraving tips are shown in both the two tipped configuration 608 and 610 and the one tipped configuration 612.

Engraving tool 600 has a three prong engraving tip which includes a two tipped configuration 606 facing an opposing single prong tip 702. Engraving tool 600 also shows an engraving tip 624 at the end of a bent head 622. Each of the tool tips are designed to create a recessed engraving line such that the recession or engraving will retain the paint wash when the paint wash is wiped away from the surface area of the figurine containing the detailed design. The engraving tool tip and the resulting cross section of the engraving recession may vary to optimize retention of the paint wash.

The various embodiments of the invention and examples shown above illustrate a novel method of applying a detailed design to a figurine or other molded product. A user of the present invention may choose any of the above embodiments or an equivalent thereof, depending upon the desired application. In this regard, it is recognized that the various forms of the subject invention could be utilized without departing from the spirit and scope of the present invention.

As is evident from the foregoing description, certain aspects of the present invention are not limited by the particular details of the examples illustrated herein, and it is therefore contemplated that the other modifications and applications, or equivalents thereof, will occur to those skilled in the art. It is accordingly intended that the claims shall cover all such modification and applications that do not depart from the spirit and scope of the present invention.

Other aspects, objects and advantages of the present invention can be obtained from the study of the drawings, the disclosure and the appended claims.

1. A method for applying a detailed design pattern to a molded object comprising the step of:
applying a paint wash to an area of a model having a detailed design of recessed lines; and
wiping away the paint wash while leaving paint wash in the recessed lines.

2. The method for applying a detailed design pattern as recited in claim 1 further comprising the steps of:
building a manufacturing mold utilizing a molded model having an original detailed design pattern of recessed lines where an exterior surface of the molded model including the original recessed lines defines the interior surface geometry of a cavity of the manufacturing mold; and
manufacturing the molded model utilizing the manufacturing mold where the detailed design of recessed lines are duplicated in the molded model.

3. The method for applying a detailed design as recited in claim 2 where building a manufacturing mold is building a manufacturing mold with steel having beryllium copper inserts.

4. The method for applying a detailed design as recited in claim 1 where the area where the paint wash is applied is pre-prepared for ease of wiping away the paint wash.

5. A method for applying a detailed design pattern to a molded object comprising the steps of:
manufacturing a molded model utilizing a mold where an interior mold cavity geometry of the mold creates a detailed design of recessed lines in the molded model;
applying paint wash to an area of the molded model having the detailed design of recessed lines; and
wiping away the paint wash while leaving paint wash in the recessed lines of the detailed design.

6. The method for applying a detailed design as recited in claim 5 further comprising the steps of:
covering the area having the detailed design with a mask adapted to substantially mask the area except an area of the recessed lines such that the paint wash can be applied to the recessed lines.

7. A method for applying a detailed design pattern to a molded object comprising the steps of:
manufacturing a molded model utilizing a mold where a geometry of an interior of a mold cavity of the mold creates a detailed design of recessed lines in a surface area of the molded model and creates raised areas between the recessed lines;
covering the surface area with mask that substantially covers the raised areas of the surface area; and
spraying paint in the recessed lines of the surface area.

8. The method for applying a detailed design as recited in claim 7 further comprising the steps of:
removing the mask and wiping away the paint wash while leaving paint in the recessed lines of the detailed design.

9. A method for applying a detailed design pattern to a molded object comprising the steps of:
a. creating a detailed design of recessed lines in a master model;
b. building a mold utilizing the master model where an exterior surface of the master model including the recessed lines defines the interior surface geometry of the mold cavity;
c. manufacturing a molded model utilizing the mold where the detailed design of recessed lines is duplicated in the molded model;
d. applying a paint wash to an area of the molded model having the detailed design of recessed lines; and
e. wiping away the paint wash while leaving paint wash in the recessed lines of the detailed design.

10. The method for applying a detailed design as recited in claim 9 where creating a detailed design of recessed lines is performed by a sculpting tool having a tip operable to engrave the recessed lines with a substantially v-shaped cross section.

11. The method for applying a detailed design as recited in claim 9 where building a mold is building a manufacturing mold with steel having beryllium copper inserts.

12. The method for applying a detailed design as recited in claim 9 further comprising the steps of:
preparing a surface of the molded model having the detailed design such that the paint wash is wiped away with ease.

13. A collectable model of a subject matter comprising:
a molded model;
a portion of the model having a surface area including a detailed design pattern formed by recessed lines where the recessed lines are coated with a paint wash.

14. The collectible model of claim 13 where the recessed lines have a width from about approximately 0.25 mm to about approximately 0.5 mm and a depth from about approximately 0.1 mm to about approximately 1 mm.

15. The collectible model of claim 13 where the recessed lines form a pin-striping pattern.
